(19) United States
(12) Patent Application Publication
(10) Pub. No.: US 2018/0039947 A1
(43) Pub. Date: Feb. 8, 2018

(54) Methods And Apparatus For Entity Worth Cartography

(71) Applicant: Al Emerick Productions, LLC, Jacksonville, FL (US)

(72) Inventor: Alfred Emerick, Jacksonville, FL (US)

(21) Appl. No.: 15/667,604

(22) Filed: Aug. 2, 2017

Related U.S. Application Data
(60) Provisional application No. 62/370,276, filed on Aug. 3, 2016.

(51) Int. Cl. G06Q 10/10; G06F 17/30; G06N 5/02; G06Q 10/06

(52) U.S. Cl. CPC G06Q 10/1053; G06Q 10/067; G06F 17/30964; G06N 5/022

(57) ABSTRACT

The present disclosure relates to evaluation methods and systems that use interactive steps to develop a visualization of worth. More specifically, the present disclosure relates to an evaluation system that utilizes a combination of subjective interactive stages; subjective and objective analysis of the business, person, or concept; and visualization tools to create a statement of value of the business, person, or concept that may elicit personal, emotional, and logical responses from a target audience.

### CROSS-REFERENCE TO RELATED APPLICATION

This application claims priority to and the full benefit of U.S. Provisional Patent Application Ser. No. 62/370,276, filed Aug. 3, 2016, and titled “METHODS AND APPARATUS FOR ENTITY WORTH CARTOGRAPHY”, the entire contents of which are incorporated in this application by reference.

### BACKGROUND OF THE DISCLOSURE

The advent of the Industrial Revolution brought with it a transition from manual labor to semi or fully automated manufacturing processes using machines. Due to this increased efficiency, a new labor force was needed to oversee production, interact with a burgeoning clientele due to the potential broader reach and cheaper prices that machines facilitated, and ensure that machines were functioning by tasking employees with upkeep or working in parts of the manufacturing process that were not automated yet.

Despite the relative efficiency of these machines, individuals were still in charge of handling them and implementing systems to ensure that production was occurring satisfactorily and on time. On top of that, supervisors had to make sure that their work force was operating at the peak of their abilities to either participate in processes machines could not do yet or to maintain machines in working order. Supervisors had to train employees, make sure employees were performing satisfactorily, and service a growing community that had a need for the products facilitated by this new technology and methods of manufacture. Given the sheer number of moving parts, supervisors were not concerned with an employee's contentment, whether their abilities were optimized, or whether the tasks they were given were those they were best at. The result was long working hours under strict working conditions at an unprecedented pace set by machines, not human beings.

The shift in awareness that a content, happy work force resulted in a more productive work force occurred slowly as the centuries went on. As technology matured and allowed for streamlined efficiency, more thought and care was put into the human component of the experience. Companies started encouraging employees to find their purpose within the company, and movement between positions or specialties was encouraged more than it was before. Solutions like the lean canvas were created as a business modeling tool to help identify broader customer problems while targeting different segments of clientele. Organizations and businesses still struggle to identify how best to implement employee and customer retention while maintaining greater revenue growth. Organizations are also unable to accurately capture and take snapshot of current organization culture or gauge cultural stagnation to determine when action or change might be necessary.

### SUMMARY OF THE DISCLOSURE

What is needed, therefore, is a way to help companies, organizations, and individuals very quickly identify and authentically communicate their worth to increase their sales or marketing efforts, retain employees and customers, communicate their worth, and achieve greater revenue, growth, and sustainability while tracking the impact of these efforts. This requires a method and system that may evaluate a business, person, concept, product, service, or segment from the perspective of one or more persons, such as a potential customer, existing employee, or member of the general public, that can be dynamic to each individual need or target while also being either automated or manipulated in real-time depending on the exercise. The system may scale according to need, meaning it can be simple, immediate, and intuitive, or may range in complexity depending on information requested by the user or reviewer.

The system may also be directed inward to identify organizational culture in a moment in time, over time, and within specific periods of time using quantifiable tools and data based on or gathered from user input. This information can then be used to redirect organizational culture or to provide insight to those who need to be able to quickly access and identify what is going on with the organization's culture. With this information, a higher up, such as a chief operating officer, may be able to identify if culture shifted as a result of a new policy being instituted, a new hire becoming a part of the team, or whether there were other dynamics at play around the time there was a change in employee attitude, output, or thinking. This can highlight areas for improvement within the organization that a person can act on and improve. On an individual level, the organization can also see employees on a micro-level and be able to identify changes in performance, attitude, or output by individual.

Accordingly, the present disclosure relates to evaluation methods and systems that use interactive steps to develop a visualization and valuation of worth, both internally and self-reflective; externally and within a business; or amongst a group of peers. More specifically, the present disclosure relates to an evaluation system that utilizes a combination of subjective interactive stages; subjective and objective analysis of the business, person, or concept; and visualization tools to create a statement of worth of the business, person, or concept that may elicit personal, emotional, and logical responses from a target audience.

Further, the present disclosure provides a visualization of worth that may be easy to digest and easily sharable, allowing for a flexible communication tool that may be useful to multiple levels of communicators and may align and engage participants around an authentic voice. In some aspects, worth cartography may create a path for growth that may be universally and quickly deployable and flexible for different business sizes and states of formation.

Some aspects may include a system for generating a worth statement through worth cartography, wherein the system may include a display; one or more wireless communication interfaces; one or more memory resources. The system may also include a worth map database; and one or more processors. The system may also transmit a plurality of worth inquiries. The system may also collect a plurality of worth responses to the plurality of worth inquiries. The system may also include populate a worth map display with the plurality of worth responses. The system may also include generate a worth path including select worth responses in a logical path. The system may also include generate a worth statement including a prose statement, where the prose statement transforms the worth path into the worth statement. The system may also include present a worth statement display. Other embodiments of this aspect may include corresponding computer systems, apparatus, and computer programs recorded on one or more computer storage devices, each configured to perform the actions of the methods.

Implementations may include one or more of the following features. In some aspects, the one or more processors may be further configured to prompt input of personal ranking data related to the plurality of worth responses; receive personal ranking data. In some embodiments, the one or more processors may be further configured to access a linguistic database, where the linguistic database may assign linguistic ranking to the plurality of worth responses. In some implementations, the one or more processors may be further configured to prompt input of a personal worth path, where the personal worth path includes personally selected worth responses in a personal logical path; receive personal worth path data. In some embodiments, the one or more processors may be further configured to access a linguistic database, where the linguistic database may assign linguistic ranking to the plurality of worth responses. In some aspects, the one or more processors may be further configured to prompt input of worth statement criteria, where the worth statement criteria at least partially defines parameters of the worth statement; receive worth statement criteria. Implementations of the described techniques may include hardware, a method or process, or computer software on a computer-accessible medium.

Some aspects may include a system for creating a worth matrix, the system including: a display; one or more wireless communication interfaces; and one or more memory resources including. In some embodiments, the system may also include a worth map database including a plurality of worth map data and one or more processors. In some aspects, the system may collect a plurality of worth map data related to an entity. In some implementations, the system may compare the plurality of worth map data. In some embodiments, the system may generate a worth matrix including analytic data extracted from the comparison of the plurality of worth map data. In some aspects, the system may also include present a worth matrix display, where the worth matrix display includes a visual representation of the worth matrix. Other embodiments of this aspect may include corresponding computer systems, apparatus, and computer programs recorded on one or more computer storage devices, each configured to perform the actions of the methods.

Implementations may include one or more of the following features. In some embodiments, the plurality of worth map data may be collected from a plurality of participants. In some aspects, the plurality of participants may be from a plurality of entity segments. In some implementations, the plurality of worth map data may be collected from a single participant. In some embodiments, the one or more processors may be further configured to generate a master worth map, where the master worth map includes extracted master worth map data from the worth matrix; generate a master worth path including select master worth responses from the master worth map in a logical path; generate a master worth statement including a master prose statement, where the master prose statement transforms the master worth path into the master worth statement and presents a master worth statement display. In some implementations, this may be condensed into shorthand for the participant, such as an abbreviated pitch or paragraph setting.

In some aspects, the one or more processors may be further configured to prompt input of master worth statement criteria, where the master worth statement criteria at least partially defines parameters of the master worth statement; and receive master worth statement criteria. In some implementations, the one or more memory resources may include a linguistic database, and the one or more processors may be further configured to access the linguistic database, where the comparison further includes a linguistic analysis on the plurality of worth maps. In some aspects, the one or more processors may be further configured to retrieve master objective data from the linguistic database, where the master objective data allows for comparison of linguistically similar or adjacent worth map responses between the plurality of worth maps. Implementations of the described techniques may include hardware, a method or process, or computer software on a computer-accessible medium.

Some general aspects may include a system for scoring a worth map, the system including: a worth map server configured to: receive worth map responses to a plurality of worth inquiries, where the worth map responses include one or both text characters or images; receive a worth map display populated with the plurality of worth responses; access a worth map response database; analyze the worth map responses and the worth map display, where the analysis identifies relative significance of the worth map responses, where the significance is at least partially based on a position of the worth map responses within the worth map display; assign objective data to each of the worth map responses; generate a uniform quantitative tag for each of the worth map responses. Other embodiments of this aspect include corresponding computer systems, apparatus, and computer programs recorded on one or more computer storage devices, each configured to perform the actions of the methods.

Implementations may include one or more of the following features. In some embodiments, the one or more processors may be further configured to access a linguistic database, where the analysis further includes a linguistic analysis on the worth map responses. In some aspects, the worth map server may be further configured to receive personal ranking data related to the plurality of worth responses, where the significance is further based at least partially on the personal ranking data. In some implementations, the worth map server may be further configured to transmit objective data to a master scoring database, where the master scoring database aggregates objective data from one or more participants and entities.

In some embodiments, the worth map server may be further configured to access the master scoring database; and retrieve aggregated objective data related to the worth map responses, where the significance is further based at least partially on retrieved aggregated objective data. In some implementations, the one or more memory resources may include a predictive analytics database, and the one or more processors may be further configured to access the predictive analytics database, where the analysis further includes a predictive analysis on the worth map responses. Implementations of the described techniques may include hardware, a method or process, or computer software on a computer-accessible medium.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates exemplary method steps for a worth cartography process.

FIG. 2 illustrates exemplary method steps for presenting questions to participants for the interactive portion of worth cartography.

FIG. 3 illustrates exemplary process flow steps according to some embodiments of the present disclosure.

FIG. 4 illustrates an exemplary worth map according to some embodiments of the present disclosure.

FIG. 5 illustrates an alternate exemplary worth map according to some embodiments of the present disclosure.

FIG. 6 illustrates exemplary worth themes according to some embodiments of the present disclosure.

FIG. 7 illustrates an exemplary worth statement according to some embodiments of the present disclosure.

FIG. 8 illustrates an exemplary processing and interface system according to some embodiments of the present disclosure.

FIG. 9A illustrates an exemplary graphical user interface (GUI) of a worth map according to some embodiments of the present disclosure.

FIG. 9B illustrates an alternate exemplary graphical user interface (GUI) of a worth map according to some embodiments of the present disclosure.

FIG. 10 illustrates an exemplary graphical user interface (GUI) for entity registration.

FIG. 11 illustrates an exemplary graphical user interface (GUI) for worth cartography initiation.

FIG. 12 illustrates an exemplary graphical user interface (GUI) of a worth map.

FIG. 13 illustrates an exemplary graphical user interface (GUI) of a worth path.

FIG. 14 illustrates an exemplary graphical user interface (GUI) of worth map management.

FIG. 15 illustrates an exemplary word of worth matrix according to some embodiments of the present disclosure.

### DETAILED DESCRIPTION

The present disclosure provides generally for a method of evaluating persons, companies, or traits. According to the present disclosure, worth cartography may be used to assess an entity for value, based on predefined parameters and measures.

The present disclosure relates to evaluation methods and systems that use interactive steps to develop a visualization of worth. More specifically, the present disclosure relates to an evaluation system that utilizes a combination of subjective interactive stages; subjective and objective analysis of the business, person, or concept; and visualization tools to create a statement of worth of the business, person, or concept that may elicit personal, emotional, and logical responses from a target audience. This data capturing tool can be implemented in various levels to provide an entity with deeper insight into a customer base, their employees, or defining internal or external goals.

In the following sections, detailed descriptions of examples and methods of the disclosure will be given. The description of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Worth Cartography: as used herein refers to an entity evaluation system utilizing a combination of one or more interactive steps, visualization, evaluation steps, analytics, summation, formation, and structuring.
Entity: as used herein refers to a person, company, or trait that may be evaluated using worth cartography. As a non-limiting example, an entity may include a person, such as an employee, a manager, a CEO, or individual; multiple persons, such as a seminar or training group, customer base, a team, or a particular demographic segment (including a member of the general public); an organization, such as a company or club; a brand; or a destination, such as a restaurant, museum, zoo, or concert venue.
Participant: as used herein refers to any person or group who may be providing responses during interactive steps of the worth cartography process. The participant may or may not represent the entity, and the appropriate participant may depend on the entity being evaluated. For example, where the entity is a brand, the participant may be a member of the marketing department who may have more insight into the branding than a software developer in the same company.
Worth Map: as used herein refers to the visualization of the responses provided in the interactive stage of the worth cartography. In some embodiments, the worth map may further provide visualization of the evaluation and summation stages.
Worth Matrix: as used herein refers to an organizational view of worth-flow based on input from one or more entity segments. In some aspects, a worth matrix may be based on multiple maps from a single participant, wherein the matrix may provide insight to the participant's perceived worth over time or a participant's morale as it relates to an entity, as non-limiting examples. In some embodiments, the worth matrix may be based on maps from multiple participants who may be part of the same or different segments within an entity. For example, segments may include employees within a department, customers within a demographic, executives, managers within management positions. In some implementations, this can provide a cascading or referring impact to each entity segment.
Worth Path: as used herein refers to the ordering and linking of the responses provided during the interactive stage. In some aspects, the worth path may provide visualization of the evaluation stage. In some embodiments, the worth path may be developed internally where the exact worth path may not be provided to the participant. The worth path may be used to develop a worth statement.
Worth Statement: as used herein refers to the resulting prose developed based on a summation of the worth path and the assessed worth of the entity. In some aspects, the worth statement may be further based on participant preferences, goals of the worth cartography, or other factors.

The present disclosure describes a process and method that may provide for strategic alignment, engagement, and growth that may help organizations identify and communicate value. In some aspects, worth cartography may be an ongoing process, wherein the process and evaluation may occur repeatedly over time and with a variety of participants, allowing the organization to continually improve and engage their customers, employees, investors, or other relevant groups. Entities may utilize worth cartography to increase marketing and sales efforts, satisfy and retain customers, and engage and empower employees.

In some implementations, worth cartography may directly impact sales and marketing, such as by increasing lead generation and response rates, improve close ratios, enhance sales talent skills at multiple levels, and strengthen messaging. In some aspects, worth cartography may improve customer alignment and employee engagement. For example, worth cartography may improve satisfaction and retention, increase lifetime customer value, create brand champions, and clarify the voice of the customer. As another example, worth cartography may prompt authentic feedback from employees, allow employees to identify their own value as it may relate to the entity, and increase productivity, customer service, and long-term value.

In some embodiments, the worth cartography process may collect data from a variety of segments. In some implementations, this data can be deployed and processed in real time and compared to other data sets. In some aspects, the system can assign values to input responses and create a ranking value based on each segment or some other threshold set by an entity or participant. For example, the entity may determine that a certain customer segment is desirable for a new marketing campaign. The system can weigh entries by those participants more heavily than others while providing a decision-maker with a report condensing and summarizing what those values are.

As an illustrative example, a marketing campaign developed for life insurance may want to see what resonates with single fathers raising children on their own, which represents a new target demographic marketers want to pursue. By polling fathers from all walks of life, the ones that identify as raising children on their own may or may not have similarities with other fathers who do not have the same personal situation. Pulling from this pool, the system can compare information and create a worth matrix to provide a report on what those similarities are and what the differences are. The differences the system identifies may be the distinguishing the direction, angle, or data needed that the marketing campaign can focus on as they develop their ideas.

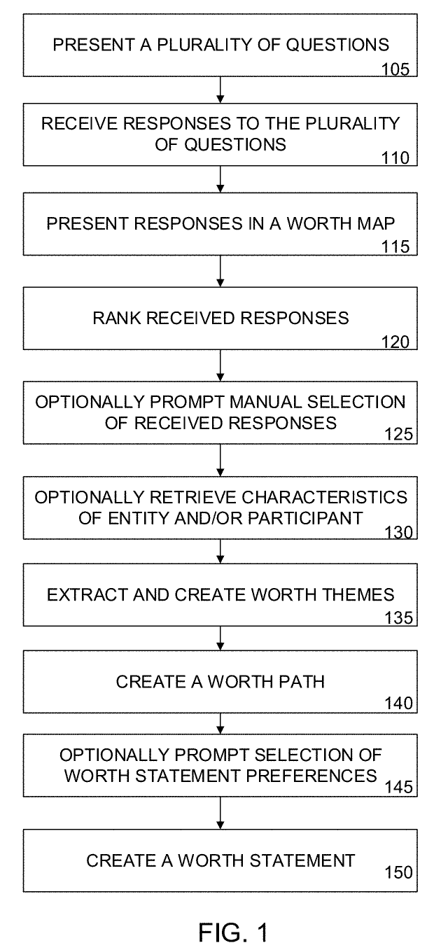

Referring now to FIG. 1, exemplary method steps for a worth cartography process 100 are illustrated. At 105, a plurality of questions may be presented to one or more participants. At 110, responses to the plurality of questions may be received. At 115, the responses may be presented in a worth map. At 120, the responses may be ranked and organized, wherein the ranking may be based on one or more predefined criteria. For example, the responses may be ranked based on detected sincerity, accuracy, or occurrence, wherein repeated terminology or synonyms may be ranked higher than isolated words or phrases. In some implementations, questions may be generated based on the who the entity is or the problem to be addressed. For example, a participant may select “customer growth” as a starting point for questions generated around addressing that focus.

In some embodiments, at 125, manual selection of received responses may be prompted. For example, as part of the interactive segment, a participant may be forced to select some of the responses to be included in the worth path. The process of selecting may help a participant learn to identify and define the worth of the entity. In some aspects, the selected responses may be an indication of sincerity or relevance, which may be used in the ranking at step 120.

In some implementations, at 130, characteristics of one or both the entity or participant may be retrieved and/or received. In some aspects, objective characteristics of a company entity, such as industry, gross revenue, number of employees, or corporate structure, may be useful in providing parameters and context to one or more the responses received at 110, the ranking at 120, or the selection at 125.

As an illustrative example, a response to a question regarding purpose of the entity may be “to serve,” and a response to how the entity makes others feel may be “restored.” Those responses may carry different significance depending on the entity type, such as a faith-based organization, a law firm, or a hospital. A faith-based organization may serve a deity and its patrons may have their faith restored. A law firm may serve justice, and its clients may feel like they have been restored from the damages caused by another party. A hospital may serve the community or the wounded, and its patients may feel their health has been restored. Information regarding characteristics of an entity may allow for a more useful, relevant, and effective worth statement.

At 135, worth themes may be extracted and developed from the responses received at 110. Worth themes may comprise permutations of combinations of responses from one or more questions and categories, wherein the combinations may indicate some part of the entity's worth. For example, responses to questions regarding the problem solved by the entity may be combined with the solution to that problem that the entity offers.

At 140, a worth path may be developed based on one or more of the previous steps, such as the ranking at 120 or the worth themes developed at 135. In some embodiments, at 145, selection of worth statement preferences may be prompted. For example, preferences may include length, audience, media type, purpose of the worth statement, or other predefined criteria. At 150, a worth statement may be created, wherein the worth statement may be prose, constructed from the information gathered from steps 105-145. In some aspects, the length, perspective, tone, and focus of the worth statement may be tailored to predefined criteria, such as the preferences received at 145, characteristics of the entity and/or participant retrieved at 130, or other relevant criteria.

As an illustrative example, an individual salesperson may respond to a plurality of questions presented at 105, wherein the questions may regard a product the individual sells. The salesperson may want a worth statement that she may present to potential buyers that may encourage purchase of the product. The salesperson may generally have thirty seconds to capture a potential buyer's attention and then an additional five to ten minutes once she has a captivated audience. Accordingly, two worth statements may be created at 150, one for the thirty-second pitch and one for the five to ten-minute pitch.

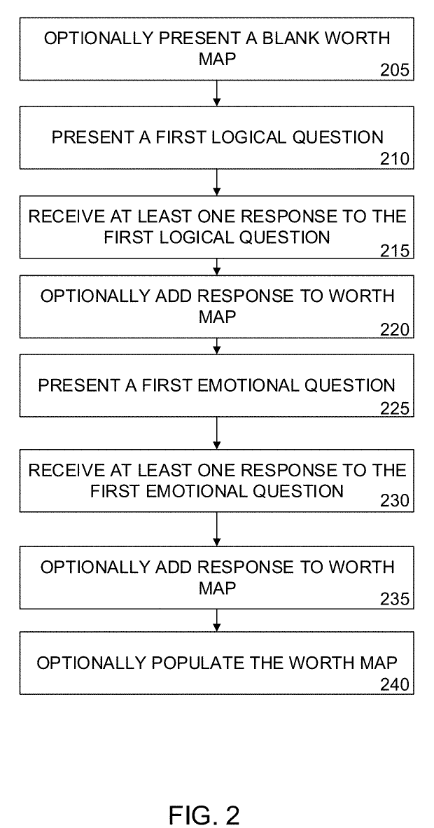

Referring now to FIG. 2, exemplary method steps for presenting questions to participants for the interactive portion of worth cartography are illustrated. In some aspects, at 205, a blank worth map may be presented. At 210, a first logical question may be presented, and at 215, at least one response to the first logical question may be received. In some embodiments, at 220, the response received at 215 may be added to the worth map. At 225, a first emotional question may be presented, and at 230, at least one response to the first emotional question may be received.

In some implementations, at 235, the response received at 230 may be added to the worth map. In some embodiments, the addition of responses into the worth map may occur live, wherein responses may be added to the worth map as they are received. In some implementations, the addition of responses may occur once all responses for a particular question may be received.

In some embodiments, the responses may be filtered, wherein some responses may be ignored or not added to the worth map based on predefined parameters, such as, for example, preferences, relevance, repetition, or employer restrictions. For example, an employer may limit the number of responses received by any one employee, which may encourage participation of more employees. As another example, an entity may be a product, and the purpose of the worth cartography may be to assess, define, and articulate the value of the product to customers. Accordingly, responses related to the manufacturer, vendors, or salespeople may be deemed irrelevant.

In some aspects, at 240, the worth map may be populated with the responses received at 215 and 225. In some embodiments, the population of the worth map may occur after receipt of responses to two or more questions, wherein a participant may not see a live addition of responses to the worth map. A delayed population may allow a participant to respond to each question independently with limited ability to reference prior responses. In some implementations, the responses may populate the worth map in question groups, such as all emotional questions, all logical questions, paired emotional and logical questions, or other groupings.

In some aspects, the response population may occur based on a predefined parameter. For example, the responses may be compared to each other, and repeated responses and synonyms may be ignored, ensuring that only unique responses may be added to the worth map. As another example, the opposite may occur, wherein only repeated responses and synonyms may be added to the worth map. In some embodiments, the comparison may be limited to responses within a single question, a question group, or the entire set of received responses. In some implementations, questions may be recorded, tracked, or responded to via a variety of methods, ranging in complexity from a white board to sheets of paper to application programs.

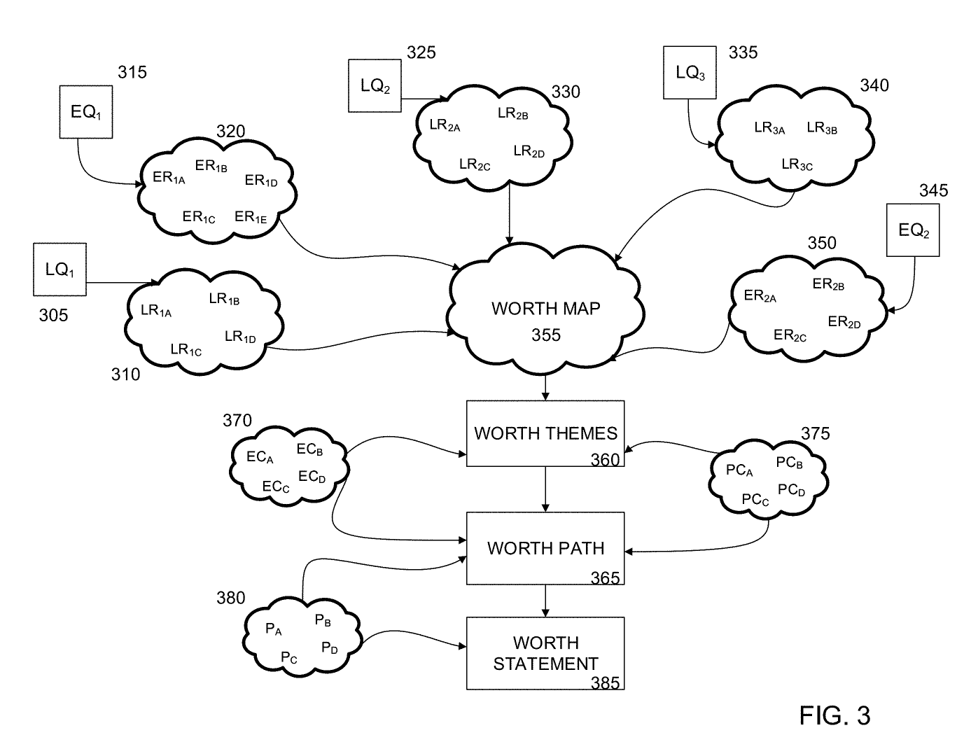

Referring now to FIG. 3, exemplary process flow steps are illustrated. At 305, 325, 335, logical questions may be presented, and at 315, 345, emotional questions may be presented. One or more responses to the logical and emotional questions may be received at 310, 320, 330, 340, 350. The one or more responses may populate a worth map at 355. At 360, worth themes may be extracted and developed from the worth map, and at 365, one or more worth paths may be developed from the worth themes and worth map. At 385, one or more worth statements may be developed from the worth themes and worth path.

In some embodiments, at 370, entity characteristics may be received, and at 375, participant characteristics may be received. In some aspects, at 380, preferences may be received. In some implementations, one or more the entity characteristics, participant characteristics, and preferences may be directly input, such as by a participant, seminar leader, or employer. In some aspects, one or more the entity characteristics, participant characteristics, and preferences may be received from a database. For example, objective entity or participant characteristics may be received from a government database, such as from state registration bodies, the U.S. Securities and Exchange Commission, or the Internal Revenue Service, as non-limiting examples. In some aspects, objective participant characteristics may be received from private sources, such as from the employer or third parties.

In some aspects, one or more subjective entity characteristics, subjective participant characteristics, or preferences may be received from third parties. For example, information may be acquired from online reviews of an entity or participant, social media related to the entity or participant, or other sources where third parties, such as clients, customers, or vendors, may input opinions about the entity or participant.

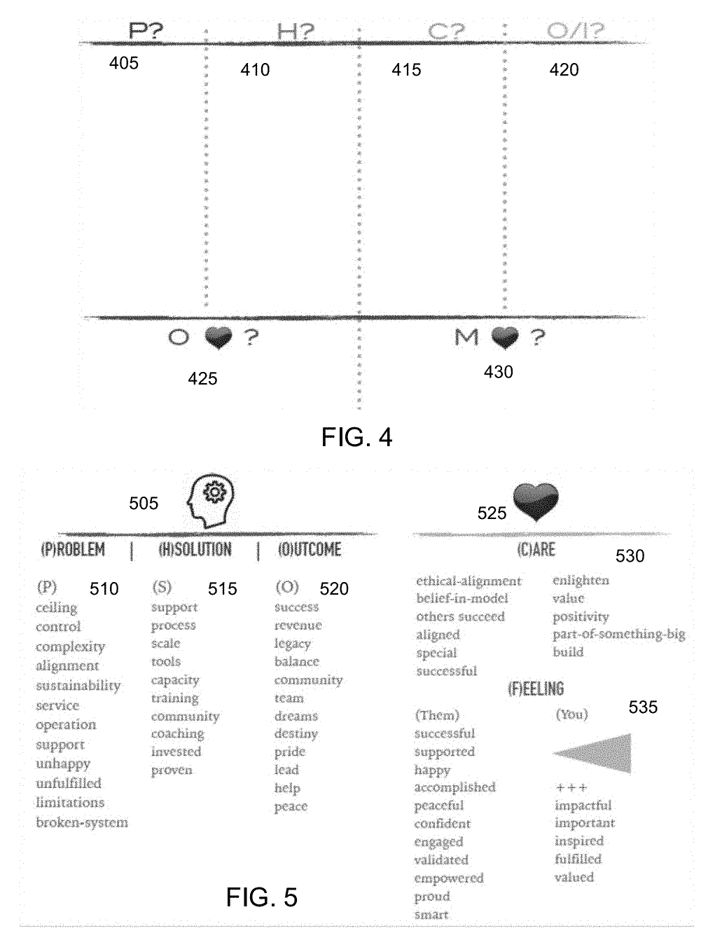

Referring now to FIG. 4, an exemplary worth map is illustrated. In some aspects, some questions may be listed as individual question headings 405, 410, 415, 420, wherein responses may be populated in a column form below the question headings 405, 410, 415, 420. In some embodiments, one or more emotional questions may be presented as individual emotional question headings 425, 430, wherein responses may be grouped below the individual emotional question headings 425, 430.

In some implementations, the presentation of responses to logical questions in an organized, columnar manner may visually confirm the logical nature of the questions in contrast to a more freeform presentation of the responses to emotional questions. In some aspects, as a part of the interactive stage, a participant or participants may be engaged to manually populate the worth map, wherein the exercise of placing responses to logical questions in a columnar fashion may encourage and reinforce the logical nature in comparison to the more freeform population of the emotional question sections.

In some embodiments, the arrangement of the responses in one or both the logical question section and emotional question sections may be analyzed and evaluated, wherein the placement analysis may be integrated into developing one or more of the worth themes, worth paths, and worth statements.

Referring now to FIG. 5, an alternative exemplary worth map is illustrated, wherein responses to logical questions and emotional questions have been populated in their respective sections. In some aspects, a worth map may visually indicate a grouping of logical question responses 510, 515, 520 with a logic icon 505. In some implementations, a worth map may visually indicate a grouping of logical question responses 530, 535 with an emotion icon 525. In some aspects, potentially subjective questions that blend logical and emotional responses may be organized by entity priority or value guidance.

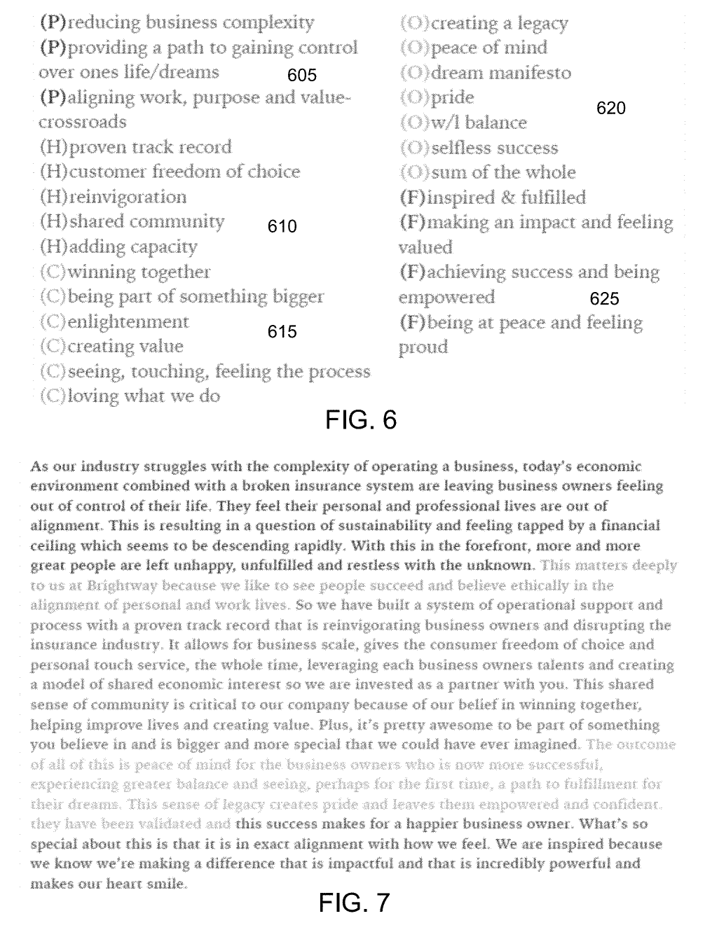

Referring now to FIG. 6, exemplary worth themes 605, 610, 615, 620, 625 are illustrated. In some aspects, worth themes 605, 610, 615, 620, 625 may be developed from responses to each question separately, wherein each worth theme 605, 610, 615, 620, 625 may relate to each question independently. In some embodiments, worth themes 605, 610, 615, 620, 625 may be developed from responses to each question separately and modified based on worth themes from other questions. In such aspects, the worth themes 605, 610, 615, 620, 625 may be normalized to the context of the responses as a whole. In some implementations, external information, such as those described in FIG. 3 at 370, 375, may be used to drive or guide the development of the worth themes 605, 610, 615, 620, 625. In some aspects, an entity may assign values or rank worth themes by internal importance. For example, an entity looking to screen employees before they can interview with the company may tell the system that worth themes representing honesty and authenticity are most important to them. A participant can go through the worth cartography process and, depending on the worth themes developed, may proceed to the next phase of an interview process.

Referring now to FIG. 7, an exemplary worth statement is illustrated. In some aspects, the worth statement may be presented to indicate the adaptation of the respective worth theme from the respective questions. In some embodiments, the worth statement may be modified based on external information or preferences such as described in FIG. 3 at 370, 375, 380. In some implementations, the worth statement may be manipulated or reorganized by the participant or entity to authentically represent or portray a goal.

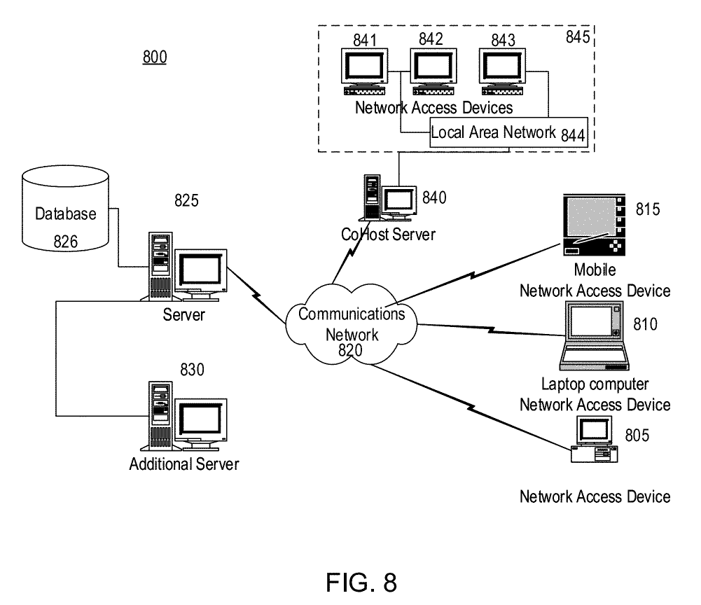

Referring now to FIG. 8, an exemplary processing and interface system 800 is illustrated. In some aspects, access devices 815, 810, 805, such as a mobile device 815 or laptop computer 810 may be able to communicate with an external server 825 through a communications network 820. The external server 825 may be in logical communication with a database 826, which may comprise data related to identification information and associated profile information. In some examples, the server 825 may be in logical communication with an additional server 830, which may comprise supplemental processing capabilities.

In some aspects, the server 825 and access devices 805, 810, 815 may be able to communicate with a cohost server 840 through a communications network 820. The cohost server 840 may be in logical communication with an internal network 845 comprising network access devices 841, 842, 843 and a local area network 844. For example, the cohost server 840 may comprise a payment service, such as PayPal or a social network, such as Facebook or a dating website.

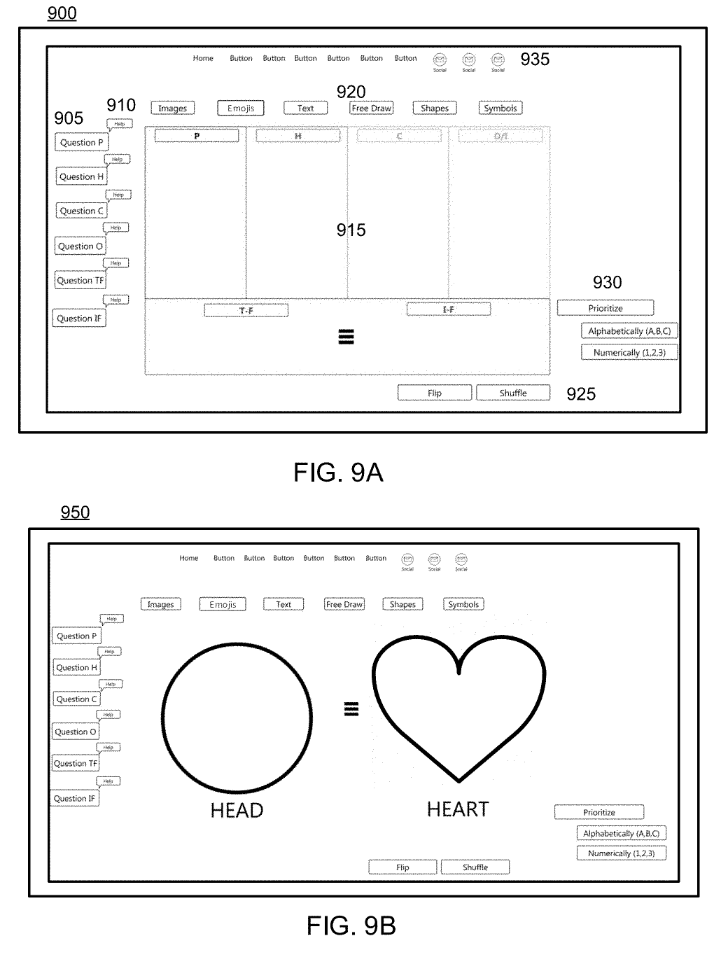

Referring now to FIGS. 9A-9B, an exemplary graphical user interface (GUI) 900 and an exemplary alternate graphical user interface (GUI) 950 of a worth map is illustrated, wherein the GUI 900 and alternate GUI 950 may be accessible through web-based applications of the present disclosure. In some aspects, a series of questions 905 may be presented, wherein each question may be associated with a respective response box 915. In some embodiments, each prompt for the series of questions 905 may comprise a help key 910 that may provide further information or guidance on each of the questions.

In some aspects, the help key 910 may comprise a standard information icon, such as an “I” or “?” or “help” in a box or circle. A participant may access the additional information or guidance by interacting with the help key 910 in a predefined manner, such as by hovering over the help key 910 or clicking on the help key 910. For example, hovering may prompt the appearance of a help box that may contain the additional information or guidance, wherein the help box may disappear when the controller is moved off the help key 910. As another example, clicking on the help key 910 may prompt an opening of a help box, which may exist within the GUI 900 window, may open in an independent new tab or window, or may open an independent static help window.

In some embodiments, the responses may be manually input into each respective response box 915. In some aspects, manual input may allow for a direct typing of responses into a response box 915. In some implementations, a GUI 900 may provide response input options 915, wherein responses may be added into response boxes 915 utilizing one or more methods, including for example, direct text input; image, icon, emoji, symbol, shape selection; or free draw. For example, responses may be selected from an image bank, wherein the images may be explicit responses or evocative response. As an illustrative example, a participant may select a happy face emoji to explicitly indicate happiness, and a serene pastoral image to evoke a feeling of peacefulness.

In some embodiments, clicking one of the response option buttons 920 may prompt the appearance of a dropdown box or a pop-out window, wherein images may be selected or dragged and dropped into the worth map. In some aspects, clicking one of the response option buttons may trigger an alternate GUI, wherein the alternate GUI 950 may comprise an interface specific to the response option type.

For example, clicking on the image response option button may trigger an alternate GUI 950 that allows for the fluid interaction between image selection and placement of the image within the worth map. In some implementations, the alternate GUI 950 may provide an alternate worth map. For example, an image response interface may allow for a grid-like or web-like arrangement of responses within each response box.

In some embodiments, predefined response options may allow for a range of selection methods. For example, a participant may directly select and drop responses into the appropriate response box, such as where the GUI 900 may be accessed through a personal access device, including a tablet, desktop computer, laptop, or kiosk. In some aspects, a participant may interact indirectly with the GUI 900, such as through a coach, seminar leader, related application, or other third party interactions.

As an illustrative example, a participant or participants may be salespeople from the same company and may attend a training seminar, wherein a seminar leader may utilize worth cartography to evaluate the primary product sold by the company. The seminar leader may randomly prompt the salespeople to provide answers to the questions, and the seminar leader may add the answers to the response boxes 915. In some aspects, the salespeople may provide answers by speaking into a microphone, wherein the answers may be automatically entered and transcribed into the response boxes 915.

In some aspects, the GUI 900 may allow for a manual manipulation of the placement of responses within the worth map, such as through arrangement buttons 925 and ordering buttons 930, which may allow for some control over the development of one or more worth themes, worth path, and worth statement. In some aspects, the arrangement buttons 925 and ordering buttons 930 may be locked, such as where the interactive portion of the worth cartography may be limited to the input of responses into the worth map. In some embodiments, the GUI 900 may comprise interface options, wherein a user may toggle between screens, control the progression of the worth cartography, and share or save the worth map, as non-limiting examples.

In some aspects, the GUI 900 may be tailored for the organization, either by a user, reviewer, or proctor. In some implementations, the GUI 900 or a proctor may generate user and organization questions depending on need. In some aspects, the GUI 900 or a proctor may create additional questions in real-time. In some embodiments, questions may be vetted and implemented “worth”-wide to be used on other evaluations within an organization, or questions may be sent to a server to be implemented throughout the entire system based on user or reviewer feedback. For example, an organization may implement the above to evaluate their members. Based on need, the organization selects certain questions to poll those who participate in the evaluation. The organization may find that some questions do not address specific situations that the organization regularly deals with, so it creates some questions during the evaluation to probe its users more thoroughly. These questions may be sent to a server where it will sit in a database bank, readily available to be used in other evaluations.

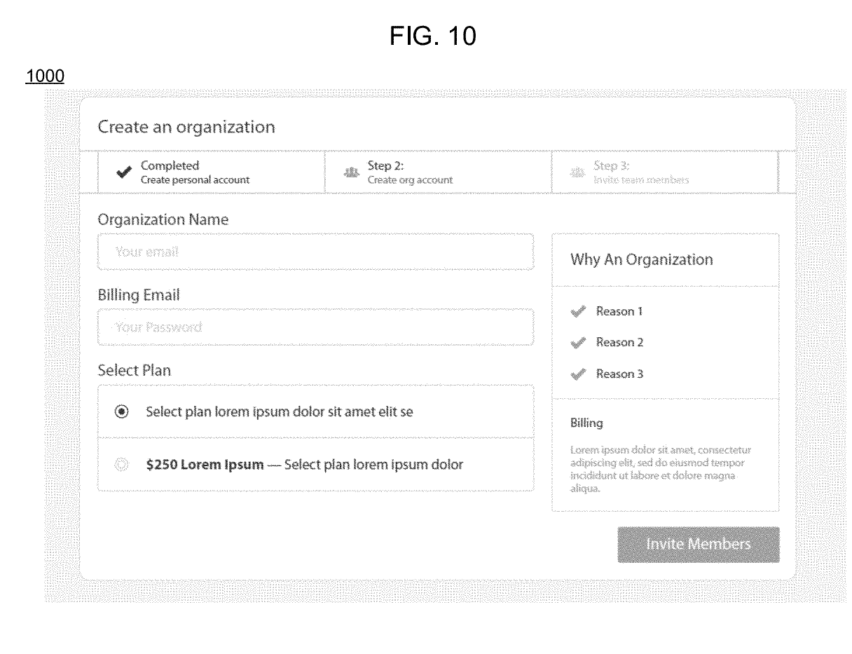

Referring now to FIG. 10, an exemplary graphical user interface (GUI) 1000 for entity registration is illustrated. In some embodiments, a participant may register for the worth cartography process. In some implementations, an entity may register for an account. In some aspects, an entity can invite participants to initiate the worth cartography process. In some embodiments, an entity may create its own portal. In some implementations, an entity can create a worth matrix through this portal. In some aspects, this allows an entity to track participants from within the same entity. In some embodiments, multiple participants from the same entity may be accessible by the entity.

In some implementations, an entity can access a participant's worth map, worth statement, or worth path. In some aspects, an entity can access various segments relating to the entity, such as employees, customers, or campaigns, as non-limiting examples. For example, an entity may track how a campaign is faring with both employees and customers to get a generalized reaction overview. This may provide an entity with enough information on the likelihood of success for a particular campaign, such as morale within the team indicating employees' belief in the campaign compared to how a customer segment is interacting with the campaign.

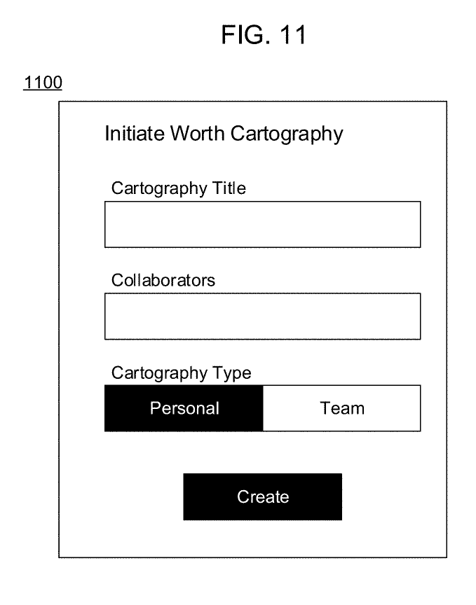

Referring now to FIG. 11, an exemplary graphical user interface (GUI) 1100 for worth cartography initiation is illustrated. In some embodiments, a participant or administrator may title a worth map. In some implementations, a participant may choose the map type, such as a personal or team map. In some aspects, if a personal map is picked, others can contribute inputs relating to the participant's worth. For example, other members from within the same department can indicate to an individual participant what they believe that participant's core strengths on the team are. In some embodiments, a team may create a worth map. In some implementations, a team worth map may relate to the entity in same way. For example, when a team creates a worth map, the team members can input how they feel about their projects, the entity's overall mission or progress towards fulfilling that mission, or how satisfactorily the team believes they are accomplishing their goals within the entity, as non-limiting examples. In some aspects, an entity may present worth inquiries to guide answers to provide feedback for the entity relating to some aspect of the entity.

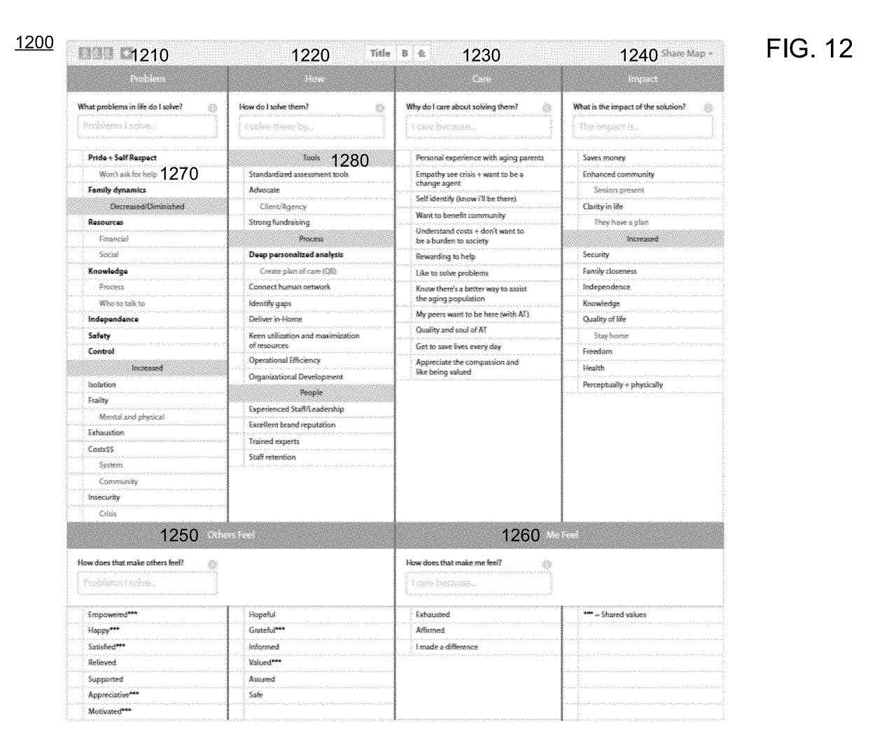

Referring now to FIG. 12, an exemplary graphical user interface (GUI) 1200 of a worth map is illustrated. In some embodiments, worth inquiries 1210, 1220, 1230, 1240, 1250, 1260 may prompt input from a participant. In some implementations, participants may populate and manipulate worth responses 1270. In some aspects, worth responses 1270 may be a combination of text or images. In some embodiments, worth responses 1270 may have arrows to indicate increases or decreases, which may also be extended beyond the literal to indicate importance or a range within the worth responses 1270. In some implementations, a worth inquiry 1220 may have a worth inquiry subcategory 1280 to help guide inquiries. For example, a worth inquiry 1220 related to how a participant solves a particular problem may include a worth inquiry subcategory asking what tools the participant uses in solving that problem.

In some aspects, worth response 1270 may be pre-populated. In some embodiments, a participant may arrange and rank their own responses within the map. This may be helpful to an entity to increase participation or shorten the worth cartography process. In some implementations, this may allow for quicker analysis between submitted maps for the worth matrix. For example, as opposed to natural language entry, which allows for a breadth and range of nuanced expression and inputs, an option with pre-populated responses may allow for more consistency between teams, participants, or departments within an entity.

By way of another example, if an entity is trying to create a worth matrix based on individual participant worth responses, the entity may have to do a holistic analysis that allows for comparison to similar and adjacent terms. Participants may write “good” or “better” as a worth response. The worth cartography system will then determine the context by using linguistic analysis and scoring. A participant may write that productivity is important to them as well as “getting things done.” The system will then determine whether a vernacular term means the same as a formal term.

In some embodiments, the worth cartography process may be conducted over various segments. In some implementations, various worth maps may be collected over various segments. In some aspects, the worth cartography system may need to normalize terms if an entity requests comparisons between diverse departments. In some embodiments, the worth cartography system may imply ranking and scores based on modifiers.

For example, a management team and a manufacturing team, though employed with the same entity, may not have the same focus or use the same terms to describe similar concepts or worth inquiries. This may be further demonstrated once the geographical scope of the entity's focus expands, such as in the United States, such as southern United States and the Midwest, compared to employees in India. Beyond this, it is possible that a third party, such as a proctor, helped facilitate the worth cartography process and transformed or translated answers. In this instance, the worth cartography system may provide some uniformity for an entity to indicate what terms were most important on a broad organizational level.

By way of another example, it is possible a participant uses modifiers as they respond to a worth inquiry. If people use different modifiers for the same word, such as bad service, horrible service, the worst service, the worth matrix can then compare terms on an equalized level despite the subjective meaning. In some implementations, the worth cartography system can extrapolate and determine whether words are commonly used by a participant. In some aspects, linguistic analysis between phrases as well as trends of that particular individual may be applied. In some embodiments, these terms can then be compared and analyzed with those who speak in more measured terms. In some implementations, this analysis may happen based on a single map from a single participant or over multiple maps from a single participant. In some aspects, this may be expanded outwards for a team or segment.

In some embodiments, linguistic analysis may be used to track an employee's progression to flag for an entity or administrator to the program that there has been a severe change in language used. For example, an employee may use positive terms and drastically change to negative terms over a period of six months. This may indicate to an entity that the individual is unhappy and that there is a likelihood of some change in performance, burnout, or focus.

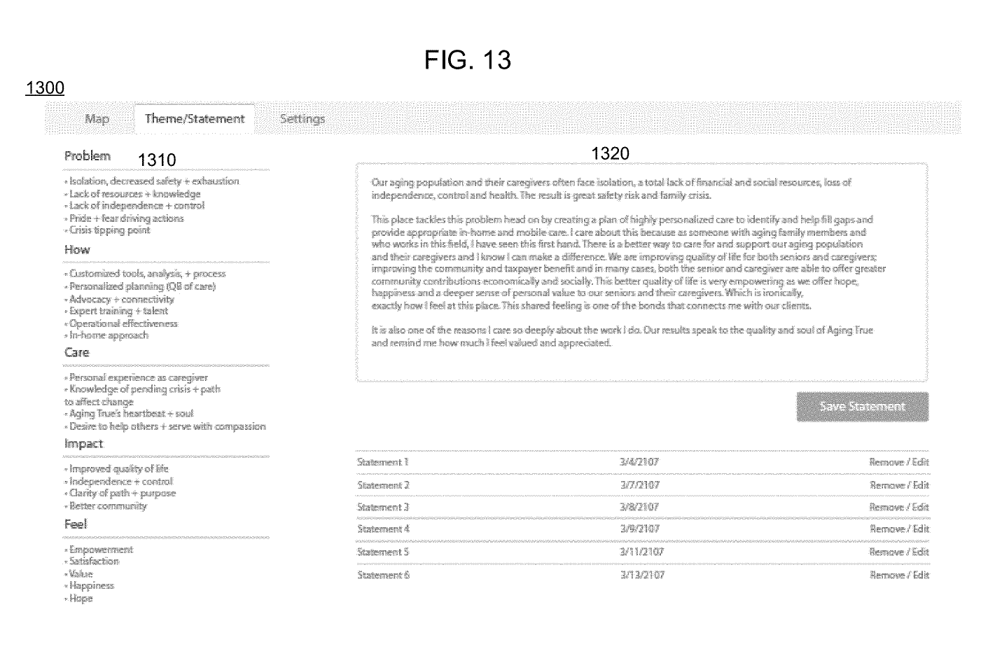

Referring now to FIG. 13, an exemplary graphical user interface (GUI) 1300 of a worth path is illustrated. In some embodiments, a participant may create a worth path 1310 based on their inputs in a worth map. In some implementations, a participant may number or rank responses within a worth path 1310. In some aspects, the worth cartography system may generate a worth path 1310 based on analysis of the participant's worth map. In some embodiments, worth paths can be compared to other worth paths. In some implementations, a worth statement 1320 may be generated based on a variety of factors, such as linguistic analysis within a map or over multiple maps, either from the same or different participants. In some aspects, a master worth path or map may be created. In some embodiments, predictive analysis with historical data may be used to create a worth statement that relates to the entity or some aspect of the entity. For example, if an entity is looking for a particular type of statement, a worth path can be created based on certain types of previously or historically inputted data.

In some embodiments, a worth statement 1320 may show or illustrate the words pulled from a worth path 1310. In some implementations, an entity may tailor the worth statement 1320. In some aspects, a 30-second pitch version or a 10 sentence mission statement for a company may be created. In some embodiments, various parameters may be imposed to create a particular type of worth statement, such as length, type of statement, purpose, or audience as non-limiting examples. For example, a worth statement 1320 for an employee may need to motivational, while a worth statement for a customer may need to be convincing,

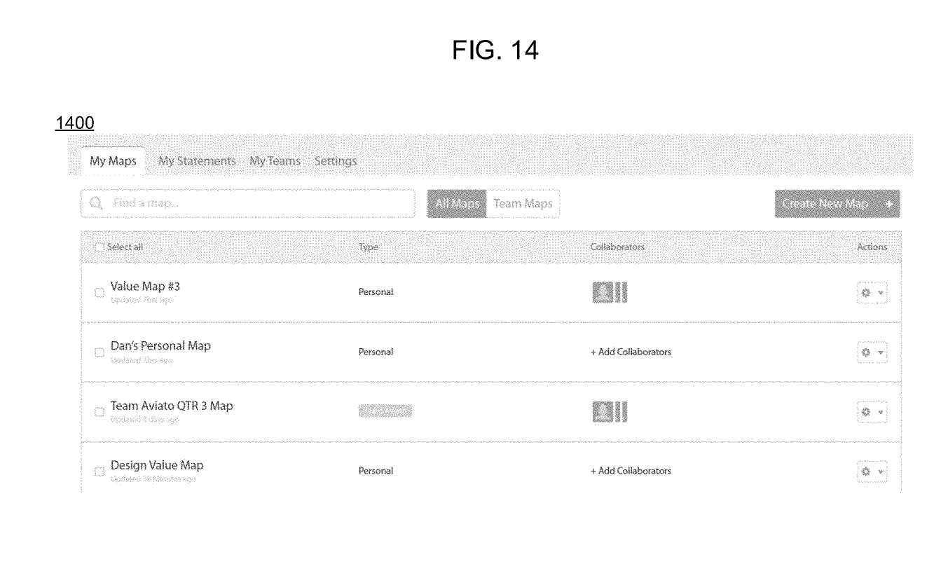

Referring now to FIG. 14, an exemplary graphical user interface (GUI) 1400 of worth map management is illustrated. In some embodiments, a participant may manage their own maps that they have create. In some implementations, an administrator may manage maps based on participants, departments, segments, or entities, as non-limiting examples. In some aspects, views may be limited based on what an entity may allow. In some embodiments, there may be an option to create a master map. In some implementations, these master maps may used to populate a worth matrix. In some aspects, a master map may be create for specific groups, such as 10 participants, a team, a department, or a customer segment, as non-limiting examples. For example, a sales representative may have multiple maps relating to different products, different lines, and different demographics for each. This sales representative may be able to view but not contribute to a master statement to make sure that their sales approach aligns with their entity's overall strategy and goals.

In some embodiments, where there may be a variety of different and diverse segments, a master map may need to be normalized over those segments using scoring or value assignments. In some implementations, this normalization may be segment agnostic. In some aspects, this may facilitate further comparison of maps on a generalized level.

In some aspects, the worth cartography system may recognize, excise, or mark biased, loaded, or charged language. In some embodiments, an entity may determine whether these terms are important. For example, an entity that advocates against the inhumane treatment of animals may want to employ charge or impassioned language in their messaging or campaigns.

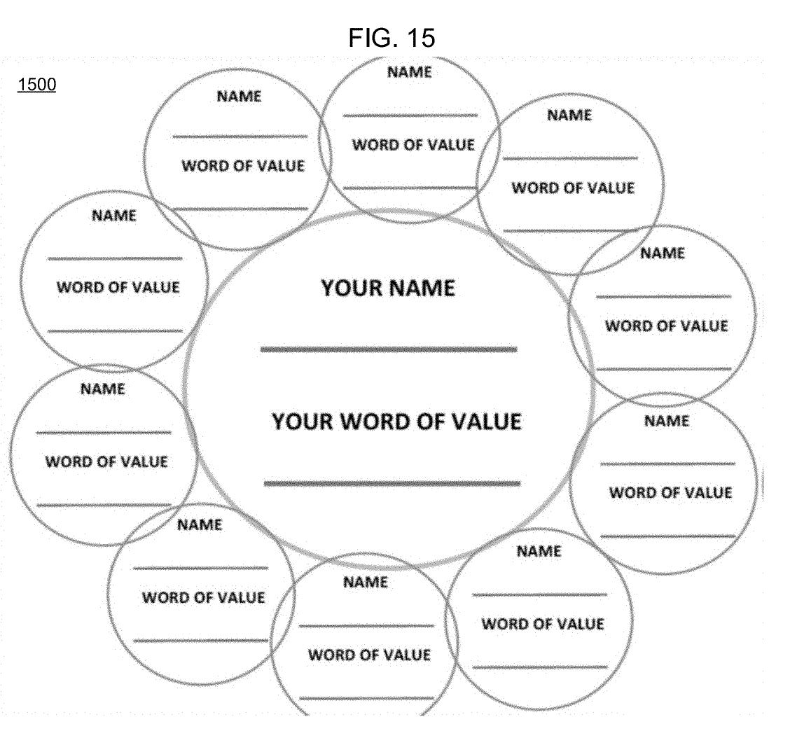

Referring now to FIG. 15, an exemplary word of worth matrix 1500 is illustrated. In some embodiments, participants may accelerate the process of generating a worth statement or worth path by collaborating on a word of worth matrix 1500. In some implementations, a word of worth matrix 1500 may start with a central problem or issue that a team or individual is looking to solve. In some aspects, a participant may fill in a single word to start a discussion with an entity or other participants. In some embodiments, others may comment, contribute, or collaborate to further develop the word of worth matrix 1500. In some implementations, the word of worth matrix 1500 may have several sources of input, such as an entity, customer, or employee, as non-limiting examples. In some aspects, the word of worth matrix 1500 may then be fed back into the system to generate a common word of worth. In some embodiments, participants to a session may have access to each other's words of worth. In some implementations, an entity may see a participant's word of worth on an individual or team basis. In some aspects, these can be collected to then create a campaign for another worth cartography process. In some embodiments, this may ease or lead participants into the worth path process.

For example, a focus group may be asked what an entity means to them in one word. Other participants in the focus group may see each other's answers once everyone has submitted something. From there, participants can contribute to that word of worth, either expanding or narrowing the scope. If everyone in a focus group agrees that an entity makes them feel happy, this might be enough information for a team to prioritize that messaging.

### Illustrative Example

As an illustrative example, the entity may be a brokerage company that sells a service, and the participants may be the sales and marketing teams. The purpose of the worth cartography may be to develop a cohesive marketing strategy that may be implemented by the sales and marketing team. Through the worth cartography process, the participants may develop a deeper understanding of the company's potential worth as related to their clients, community, and industry.

Further, the participants may be involved in an articulation of that worth based on objective and subjective information, at least some of which the participants provide. Involving the participants may allow for the development of a worth statement that connects the participants personally to that worth statement. A personal connection and understanding may infuse the presentation of company worth from the sales and marketing team with sincerity, passion, and purpose, which may be integral to that campaign.

The series of questions may include three emotional questions and three logical questions. The three logical questions may be as follows: What problems does the company solve for its customers? How do we, as employees, and through our people, processes, and tools, solve them? What is the impact of that solution? The three emotional questions may be as follows: Why do we care about solving the problem? How does the solution and impact make others feel? How does the solution and impact make us feel?

The questions may be populated into a worth map, such as illustrated in FIG. 4, or into a worth map GUI, such as illustrated in FIG. 9A. In some aspects, the worth map may comprise question indicators, such as alphanumeric symbols, without explicitly listing the questions. The indicators may keep participants engaged in the worth cartography without shifting the focus to reading through the text.

Participants may be prompted to respond to the questions, which may be by, for example, a facilitator or seminar leader. The prompted responses may be one or more words, phrases, or images. The participants may be randomly selected to answer various questions, or a single participant may be selected to answer all the questions. The participants may also be prompted to answer one or more of the questions remotely and individually, such as through an application interface, sheet of paper, or other response methods.

In some events, the worth cartography may utilize a combination of the response techniques. For example, individuals may be asked to respond to the questions without context prior to the event, and at the event, a facilitator may prompt multiple individuals to provide various responses. Part of the exercise may be to compare individual worth mapping of the company to the worth mapping from the group.

The responses may be populated into the worth map, such as into the worth map's respective response boxes. In some events, the participants may be involved in the arrangement of the responses and the response boxes. Part of the exercise may be to encourage the participants to rank the responses based on their perceived significance, accuracy, or relevance. In some events, participants may be asked to select only a predefined number of responses from each response box.

From the responses on the worth map, worth themes, and worth paths may be developed. In some events, the worth themes and worth paths may be extracted based on predefined parameters, such as speed of response, repetition of synonyms, participant selection of responses, proximity of arranged responses to a reference point on the worth map, participant ranking of responses, or relevance between responses to different questions, as non-limiting examples.

Part of the process may include prompting participants to attempt the development of worth themes and worth paths. The participants may be prompted at random individually, or they may be prompted to break into groups to develop worth paths and themes as a team. The participants may be prompted to physically arrange the responses on the worth map, such as through a dynamic graphical user interface (GUI).

The worth map may be color-coded, wherein the questions and their respective responses may be the same color. The emotional questions may be warm colors, such as red, yellow, and orange; and the logical questions may be cool colors, such as blue, purple, and green. The colors may be consistent throughout the worth cartography, wherein the colors of the worth themes and worth path correlate to the colors of the responses they may be adapted from.

The worth statement may be broken into distinct portions, wherein each portion matches the color of the source question. For some worth cartography, blends of colors may indicate the use of responses from multiple questions. For example, if a worth theme is developed from responses to a blue question and a yellow question, the worth theme may be a distinct green.

The participant results may be integrated into and taken as additional factors for the worth themes and worth paths that may be developed based on the predefined parameters. For some events, the process of developing worth paths and themes may be repeated with different predefined parameters or prompts.

From the worth themes and worth paths, worth statements may be developed. Preferences for worth statement characteristics may include duration, intended audience, purpose, and level of formality, as non-limiting examples. As the event is intended to create marketing strategies for the sales and marketing teams, worth statements may be developed for the sales team, marketing teams, and internal use.

The worth statement for the sales team may be engaging and have a casual tone to be more relatable to potential customers. The worth statement for the marketing teams may be succinct and for a general audience so the worth statement may be integrated into advertisements. The worth statement for internal use may be structured like a mission statement focused on ideals to emotionally connect employees with their company's worth, suggesting a state of mind for employees.

Once the worth statements have been developed and conveyed, individual participants may be prompted to present the worth statement as practice. As part of the exercise, individuals may repeat the presentation in succession. In some seminars, other participants may provide feedback on the presentation, allowing the presenting individual to modify the worth statement organically to suit his personality and personal connection to the company.

The participants may be prompted to break into groups, wherein each group may finesse the worth statement to have a natural and organic tempo. The resulting worth statements may be compared between the groups. As part of the exercises, the participants may be prompted to develop worth statements individually or in groups, which may then be compared to the worth statements developed by the worth cartography system.

Multiple worth statements may be developed, wherein the worth statements may vary based on the predefined parameters previously described and may have a personal connection to individual participants. For example, some individuals may have a deeper connection with some worth themes than others, and the most effective worth statement for those individuals may place an emphasis on the worth themes they connect with.

The initial worth cartography seminar may develop the foundation for the sales and marketing teams to identify, understand, and personally appreciate the worth of the company. Periodic worth cartography exercises may maintain the personal connection between participants and their company. The continued worth cartography may occur individually, such as through a personal GUI, such as illustrated and described in FIGS. 9A and 9B, or in a group setting, which may promote camaraderie within the teams.

Periodic worth cartography may utilize the responses from the initial worth cartography seminar, prompting a participant to review and confirm responses. In some aspects, periodic worth cartography may engage the participants to go through the entire process again, wherein one or more new responses, worth themes, worth paths, and worth statements may be compared to previous responses, worth themes, worth paths, and worth statements. The comparison may allow participants to see their appreciation and connection to the company and identification and articulation of the company's worth evolve over time.

Worth cartography may not be static, wherein periodic worth cartography may allow for a fluid and flexible appreciation and articulation of value that evolves with the company over time. For example, the company may expand or contract geographically or functionally, which may prompt a reevaluation exercise in worth cartography. The sales and marketing team may undergo a substantial change in personnel, such as through layoffs or a merger, wherein worth cartography may promote morale and create a renewed sense of personal connection to the company.

The information provided may be fed into the system and preserved for future reference by the entity. The information collection may be converted into data points and assigned values based on a variety of factors, either organic or designated, such as frequency, association, resonance based on a campaign, or importance based on entity hierarchy. Weighing these values, the system can then provide a report indicating any trends. The system may also suggest further actions based on an entity's previous activities or solutions to similar trends or adjacent trends. The system can track potential pressure points as well as use historical information to indicate how a campaign or a decision point may affect a customer segment or entity employees, as non-limiting examples.

By collecting this information from the worth cartography process, an entity can have a micro and macro view of a segment it regularly analyzes. Alternatively, the entity will have quality data points for a segment that can be compared to other data points. Over time, the worth cartography process may compare and indicate trends within an industry using authentic data based on participant input. This heightens actionable insight an entity can then use to affect change on an individual, entity-wide, and organizational level.

### CONCLUSION

A number of embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A system for generating a worth statement through worth cartography, the system comprising:
a display;
one or more wireless communication interfaces;
one or more memory resources comprising:
a worth map database; and
one or more processors to:
transmit a plurality of worth inquiries;
collect a plurality of worth responses to the plurality of worth inquiries;
populate a worth map display with the plurality of worth responses;
generate a worth path comprising select worth responses in a logical path;
generate a worth statement comprising a prose statement, wherein the prose statement transforms the worth path into the worth statement;
present a worth statement display.

2. The system of claim 1, wherein the one or more processors are further configured to:
prompt input of personal ranking data related to the plurality of worth responses;
receive personal ranking data.

3. The system of claim 1, wherein the one or more processors are further configured to:
access a linguistic database, wherein the linguistic database may assign linguistic ranking to the plurality of worth responses

4. The system of claim 1, wherein the one or more processors are further configured to:
prompt input of a personal worth path, wherein the personal worth path comprises personally selected worth responses in a personal logical path;
receive personal worth path data.

5. The system of claim 1, wherein the one or more processors are further configured to:
access a linguistic database, wherein the linguistic database may assign linguistic ranking to the plurality of worth responses.

6. The system of claim 1, wherein the one or more processors are further configured to:
prompt input of worth statement criteria, wherein the worth statement criteria at least partially defines parameters of the worth statement;
receive worth statement criteria.

7. A system for creating a worth matrix, the system comprising:
a display;
one or more wireless communication interfaces;
one or more memory resources comprising:
a worth map database comprising a plurality of worth map data;
one or more processors to:
collect a plurality of worth map data related to an entity;
compare the plurality of worth map data;
generate a worth matrix comprising analytic data extracted from the comparison of the plurality of worth map data;
present a worth matrix display, wherein the worth matrix display comprises a visual representation of the worth matrix.

8. The system of claim 7, wherein the plurality of worth map data are collected from a plurality of participants.

9. The system of claim 8, wherein the plurality of participants are from a plurality of entity segments.

10. The system of claim 7, wherein the plurality of worth map data are collected from a single participant.

11. The system of claim 7, wherein the one or more processors are further configured to:
generate a master worth map, wherein the master worth map comprises extracted master worth map data from the worth matrix;
generate a master worth path comprising select master worth responses from the master worth map in a logical path;
generate a master worth statement comprising a master prose statement, wherein the master prose statement transforms the master worth path into the master worth statement;
present a master worth statement display.

12. The system of claim 11, wherein the one or more processors are further configured to:
prompt input of master worth statement criteria, wherein the master worth statement criteria at least partially defines parameters of the master worth statement;
receive master worth statement criteria.

13. The system of claim 7, wherein the one or more memory resources comprises a linguistic database, and the one or more processors are further configured to:
access the linguistic database, wherein the comparison further includes a linguistic analysis on the plurality of worth maps.

14. The system of claim 13, wherein the one or more processors are further configured to retrieve master objective data from the linguistic database, wherein the master objective data allows for comparison of linguistically similar or adjacent worth map responses between the plurality of worth maps.

15. A system for scoring a worth map, the system comprising:
a worth map server configured to:
receive worth map responses to a plurality of worth inquiries, wherein the worth map responses comprise one or both text characters or images;
receive a worth map display populated with the plurality of worth responses;
access a worth map response database;
analyze the worth map responses and the worth map display, wherein the analysis identifies relative significance of the worth map responses, wherein the significance is at least partially based on a position of the worth map responses within the worth map display;
assign objective data to each of the worth map responses;
generate a uniform quantitative tag for each of the worth map responses.

16. The system of claim 15, wherein the one or more processors are further configured to:
access a linguistic database, wherein the analysis further includes a linguistic analysis on the worth map responses.

17. The system of claim 15, wherein the worth map server is further configured to receive:
personal ranking data related to the plurality of worth responses, wherein the significance is further based at least partially on the personal ranking data.

18. The system of claim 15, wherein the worth map server is further configured to transmit objective data to a master scoring database, wherein the master scoring database aggregates objective data from one or more participants and entities.

19. The system of claim 18, wherein the worth map server is further configured to:
access the master scoring database;
retrieve aggregated objective data related to the worth map responses, wherein the significance is further based at least partially on retrieved aggregated objective data.

20. The system of claim 15, wherein the one or more memory resources comprises a predictive analytics database, and the one or more processors are further configured to:
access the predictive analytics database, wherein the analysis further includes a predictive analysis on the worth map responses.
